(19) United States
(12) Patent Application Publication
(10) Pub. No.: US 2014/0292668 A1
(43) Pub. Date: Oct. 2, 2014

(54) TOUCH INPUT DEVICE HAPTIC FEEDBACK

(71) Applicant: LENOVO (SINGAPORE) PTE. LTD., Singapore (SG)

(72) Inventors: Ethan Joshua Fricklas, Hillsborough, NC (US); Michaela Rose Case, Raleigh, NC (US); Aaron Michael Stewart, Raleigh, NC (US); Thomas John Sluchak, JR., Apex, NC (US)

(73) Assignee: Lenovo (Singapore) Pte. Ltd., Singapore (SG)

(21) Appl. No.: 13/854,478

(22) Filed: Apr. 1, 2013

(51) Int. Cl. G06F 3/041

(52) U.S. Cl. CPC G06F 3/041
USPC 345/173

(57) ABSTRACT

An embodiment provides a method, including: detecting touch input at a surface of a touch sensitive device; and activating one or more actuators to provide haptic feedback in response to the touch input at the surface of the touch sensitive device; the haptic feedback comprising a tactile indicator to created via modulating one or more of: actuator frequency, actuator amplitude, and actuator duration. Other aspects are described and claimed.

### BACKGROUND

Information handling devices (“devices”), for example cell phones, smart phones, tablet devices, laptop and desktop computers, remote controls, alarm clocks, navigation systems, e-readers, etc., employ one or more of a multitude of available input devices. Among these input devices are touch sensitive input devices, for example touch screens and touch pads having a touch sensitive surface, as well as mechanical input devices, for example pointing sticks and mechanical buttons.

Haptic feedback is commonly used in consumer electronics to provide a global response for actions such as confirming activation of controls (e.g., press and hold of an on-screen button or location) as well as providing notifications (e.g., text message received). Haptic feedback is provided using one or more actuators. Various types of actuators are used. An example actuator is a mechanical actuator that physically provides vibration via oscillation in response to electrical stimulus. Different amplitudes, frequencies and durations may be applied to an actuator to produce various forms of vibration and thus haptic feedback. For example, one vibration type may be provided to indicate a text message has been received whereas another type of vibration type may be provided to indicate a text selection action has been successfully initiated on a touch screen device.

### BRIEF SUMMARY

In summary, one aspect provides a method, comprising: detecting touch input at a surface of a touch sensitive device; and activating one or more actuators to provide haptic feedback in response to the touch input at the surface of the touch sensitive device; the haptic feedback comprising a tactile indicator created via modulating one or more of: actuator frequency, actuator amplitude, and actuator duration.

Another aspect provides an information handling device, comprising: one or more processors; a touch sensitive device having a touch sensitive surface; one or more actuators; and a memory operatively coupled to the one or more processors that stores instructions executable by the one or more processors to perform acts comprising: detecting touch input at the surface of the touch sensitive device; and activating the one or more actuators to provide haptic feedback in response to the touch input at the surface of the touch sensitive device; the haptic feedback comprising a tactile indicator created via modulating one or more of: actuator frequency, actuator amplitude, and actuator duration.

A further aspect provides a program product, comprising: a storage medium having computer program code embodied therewith, the computer program code comprising: computer program code configured to detect touch input at a surface of a touch sensitive device; and computer program code configured to activate one or more actuators to provide haptic feedback in response to the touch input at the surface of the touch sensitive device; the haptic feedback comprising a tactile indicator created via modulating one or more of: actuator frequency, actuator amplitude, and actuator duration.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1(A-G) illustrates examples of actuator characteristic modulation.

FIG. 2(A-D) illustrates examples of directional actuator pattern modulation.

FIG. 3(A-D) illustrates examples of edge actuator modulation.

FIG. 4 illustrates an example diagram of information handling device circuitry.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Haptic (or vibratory or tactile) feedback is commonly used in consumer electronics to provide a global response for simple actions such as confirming activation of controls. Also, some simple pulsed haptic feedback has provided a sense of texture. In other examples, simple, non-directional movement, e.g., a finger sensed over a touch pad, have been provided as tactile cues to a user. Nonetheless, these uses of haptic feedback have been generally limited to using haptic feedback of unaltered frequency, amplitude, duration and/or position in the input devices. These relatively simple haptic sensations consisting of a fixed frequency, duration and amplitude are used to create feedback for various situations. Most often, a single, haptic sensation of the same fixed frequency, duration and amplitude is used as global feedback for all situations within a device.

Occasionally, some devices have implemented more than one haptic sensation as feedback for different situations but each haptic feedback sensation consists of some fixed level of frequency, duration and amplitude. In any such cases, the haptic feedback comes on to convey that a user action is being acknowledged or that a function has been actuated and turns off shortly thereafter. Thus, these haptic responses convey nothing about the qualitative nature or state of the function being used, such as if the function (e.g., volume) is being increased or decreased, nor do they provide any cue as to corrective or guiding directionality.

In contrast, an embodiment provides a richer form of haptic feedback for input devices. Various embodiments intelligently employ variation to the amplitude, duration, and/or frequency of an actuator's vibration, and/or variation to the position, number, and/or timing of actuator vibration. This allows an embodiment to create a sense of directionality to the input device's haptic feedback and/or synchronization of the haptic feedback to the nature (e.g., intensity) of the input provided. A variety of examples are given throughout this description in order to provide a better understanding of these principles.

An embodiment may vary the amplitude, frequency and/or duration of haptic response based on the intended mode of feedback. Moreover, an embodiment uses actuators in various combinations and timings to create unique haptic responses for various situations. Thus, for example, haptic feedback may be used to distinguish between locations on the input device for guiding users in a direction where input may be provided. For instance, pulling an icon in an undesirable manner to the edge of the screen may result in a haptic feedback providing warning and/or a directional cue to the user for correction. It will be appreciated that, without visible information (e.g., in situations where the user is not looking at the device, or there is no display element associated with the input area), the user would greatly benefit from such non-visual, tactile cue information.

An embodiment also provides haptic feedback that gives users a sense of the intensity of their inputs, e.g., either increase or decrease associated with a function of an underlying application, e.g., volume control, zooming in/out, scrolling, etc. Therefore, an embodiment provides haptic feedback to indicate that a limit is approaching, has been reached, a level of intensity associated with the input (e.g., increasing volume), etc., for a function.

The description now turns to the figures. The illustrated example embodiments will be best understood by reference to the figures. The following description is intended only by way of example, and simply illustrates certain example embodiments.

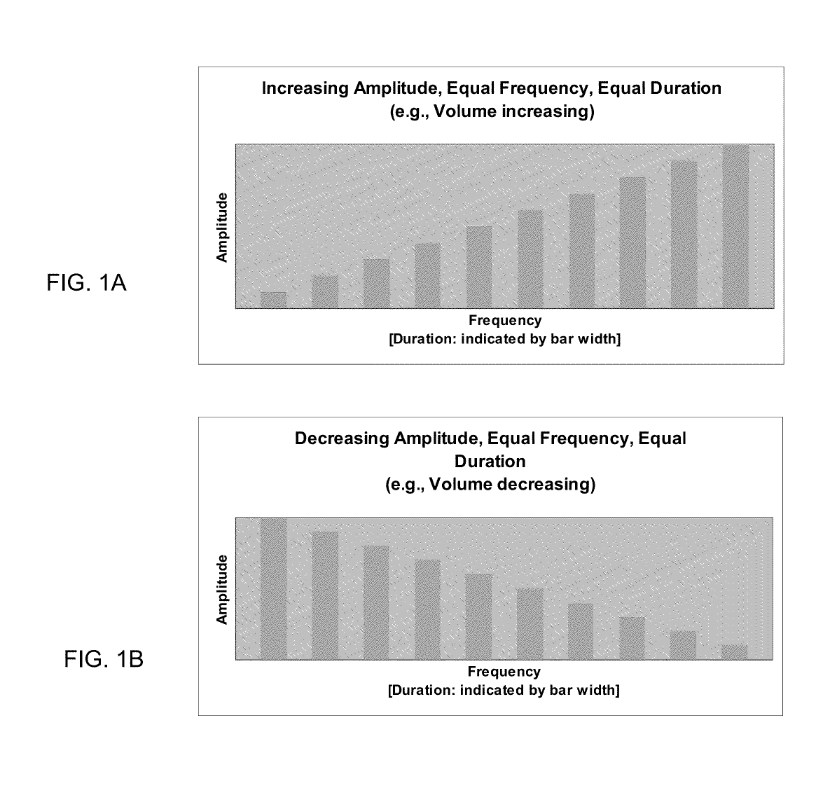

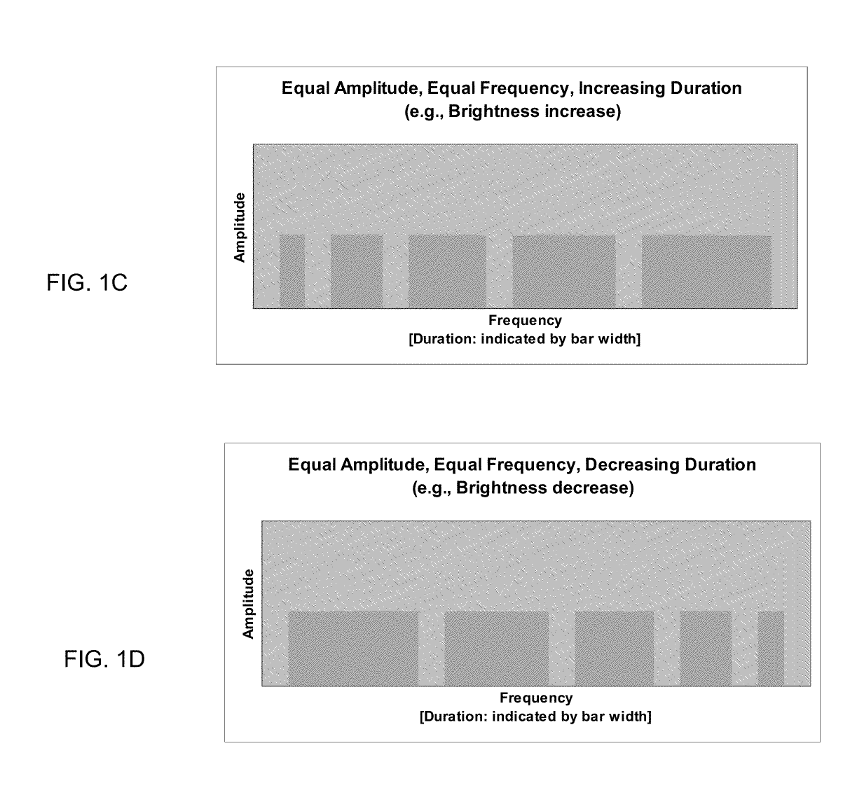

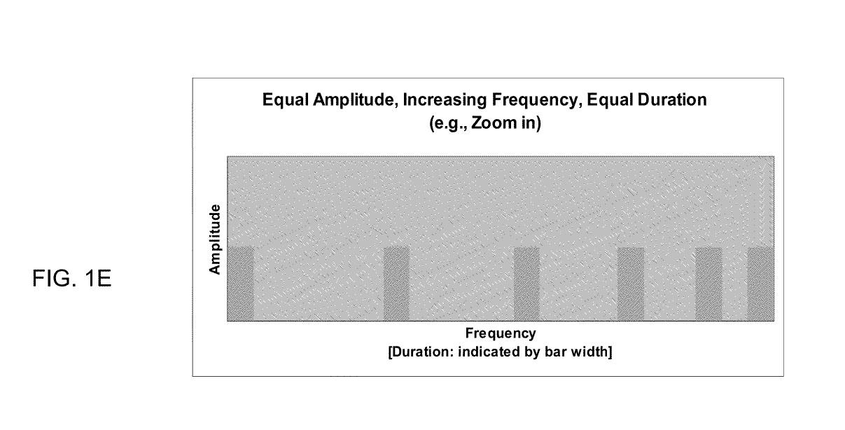

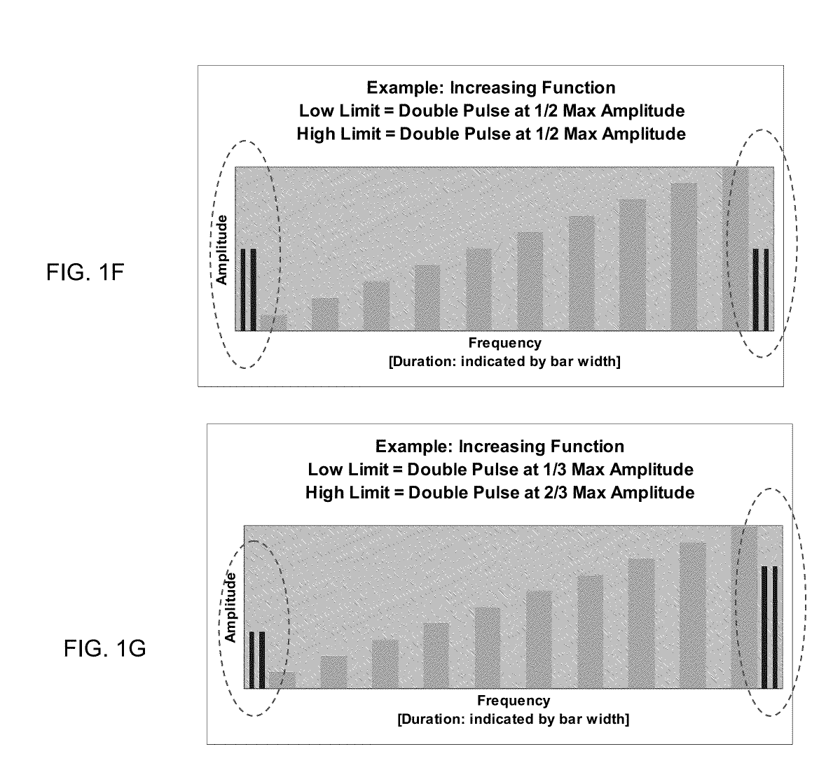

The frequency, duration, amplitude and timing of haptic response can be varied based on the capabilities of the haptic actuator(s) and the intended mode of feedback. For example, referring to FIG. 1(A-B), when using a function to decrease audible volume, perhaps for an on-screen video or audio player application, devices today might provide steady haptic feedback of a single frequency, duration and amplitude to indicate that the volume change has been initiated. However, the unchanging haptic characteristics do not indicate whether the volume is actually decreasing or increasing. Also lacking is haptic feedback to convey when a limit to the volume decrease or increase has been reached.

Accordingly, as illustrated in FIG. 1(A-G), an embodiment varies the haptic feedback such that it is synchronized to the underlying behavior of the application. For example, if a user is providing input to the audio of video application player to increase the audio, haptic feedback of increasing amplitude may be provided (FIG. 1A). Similarly, if a user is decreasing the audio player volume, e.g., using a slider function, an embodiment may provide haptic feedback having decreased amplitude (FIG. 1B).

As illustrated in FIG. 1(A-G), the increased or decreased haptic feedback may include amplitude variation, frequency variation, duration variation, variation of the number of actuators used, or a suitable combination of the foregoing. Therefore, the haptic feedback may be synchronized to the effect of the user input on the underlying application. This provides the user with a non-visual form of feedback regarding actions being performed on the device.

In the example of screen brightness increasing or decreasing, an embodiment may employ haptic duration variation (with amplitude and frequency remaining constant) to indicate corresponding increase (FIG. 1C) or decrease (FIG. 1D) of the screen brightness. In similar fashion, as illustrated in FIG. 1E, an embodiment may modulate the frequency of the haptic feedback provided, thus indicating, e.g., via increased frequency of haptic feedback, that a user is zooming in on an image.

The various vibration modulations provided by embodiments may be mixed in a variety of ways utilizing haptic actuators. For example, increasing or decreasing amplitude of haptic feedback may be combined with boundaries or edges being indicated by frequency modulation, with or without duration and/or amplitude modification, as illustrated in FIG. 1(F-G). Thus, an embodiment may use pulsed vibrations at the upper and lower limits of, e.g., audio volume, to provide a tactile feedback to the user that the upper and/or lower limits have been reached (or are approaching), in combination with the other tactile feedback, as illustrated in the non-limiting examples of FIGS. 1F and 1G. These pulsed vibrations are highlighted by the dashed ovals in FIGS. 1F and 1G.

Some devices or implementations have employed haptic feedback of a fixed amplitude and frequency to indicate movement is occurring, e.g., pulsed on and off with equal duration. Such haptic feedback, however, lacks a sense of direction of the movement and gives no indication of increase or decrease in the function represented. This type of haptic feedback thus merely attempts to indicate that some aspect of the input is changing or that input is occurring. Accordingly, an embodiment uses a haptic generating mechanism or actuator(s) to vary the haptic feedback in a systematic fashion. This in turn provides a qualitative sense of progress, and more specifically of increase or decrease, for a given function. Moreover, an embodiment provides haptic feedback to indicate that a limit of a progression (e.g., upper and/or lower) has been reached, as illustrated in FIG. 1(F-G).

To indicate or convey a sense of increase, any of the haptic feedback examples illustrated in FIG. 1(A-G) may be used. Examples therefore include haptic pulses of equal duration, occurring with consistent frequency over time, but with progressively increasing amplitude, e.g., as illustrated in FIG. 1A.

Another example includes haptic pulses of equal amplitude, occurring with consistent frequency over time, but with progressively increasing duration, e.g., as illustrated in FIG. 1C. Another example includes haptic pulses of equal amplitude, occurring with consistent duration, but with progressively increasing frequency over time, e.g., as illustrated in FIG. 1E. Additionally or in the alternative, pairs of any two haptic dimensions or characteristics (e.g., amplitude, frequency, or duration) may be utilized where two of the three haptic dimensions or characteristics are increasing. Similarly, the combination of all three haptic dimensions or characteristics may be used to provide increasing and/or decreasing haptic feedback matched with an underlying application function such as audio volume, zoom in/zoom out, or the like. In similar fashion, to indicate decrease, any of the following haptic feedback could be used: haptic pulses where only amplitude is progressively decreased, e.g. as illustrated in FIG. 1B, haptic pulses where only duration is progressively decreased, e.g., as illustrated in FIG. 1D, or haptic pulses where only frequency is progressively decreased over time.

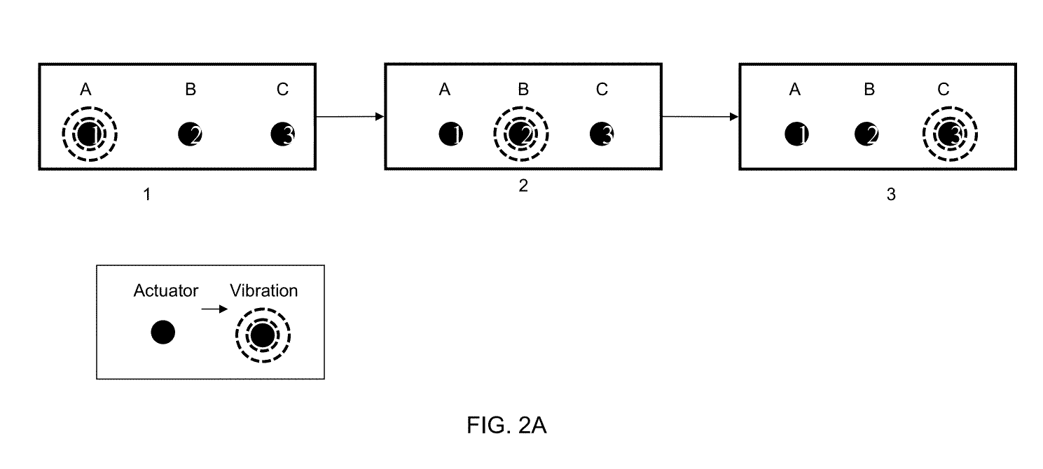

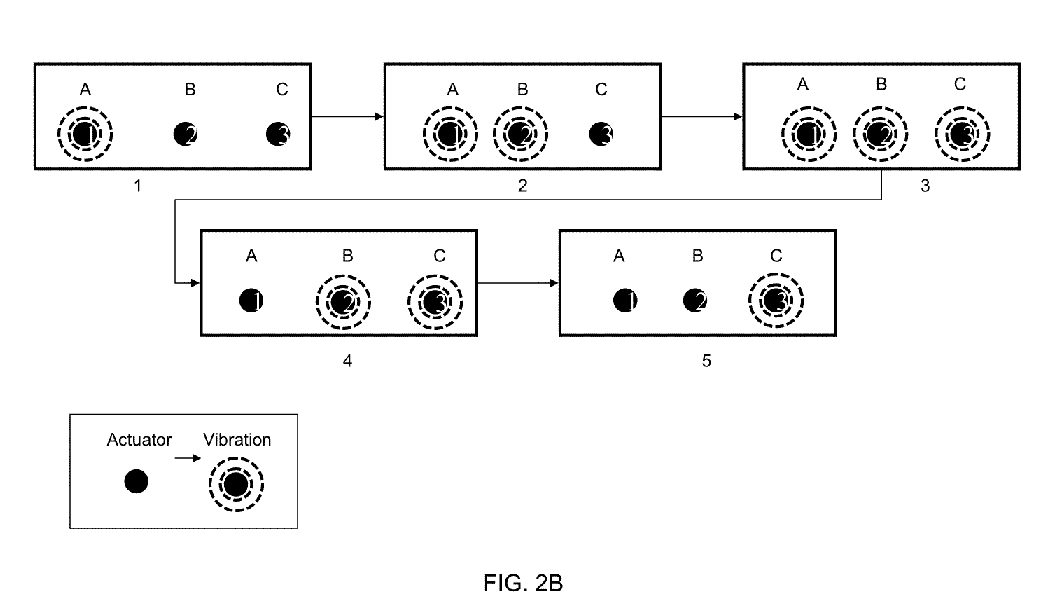

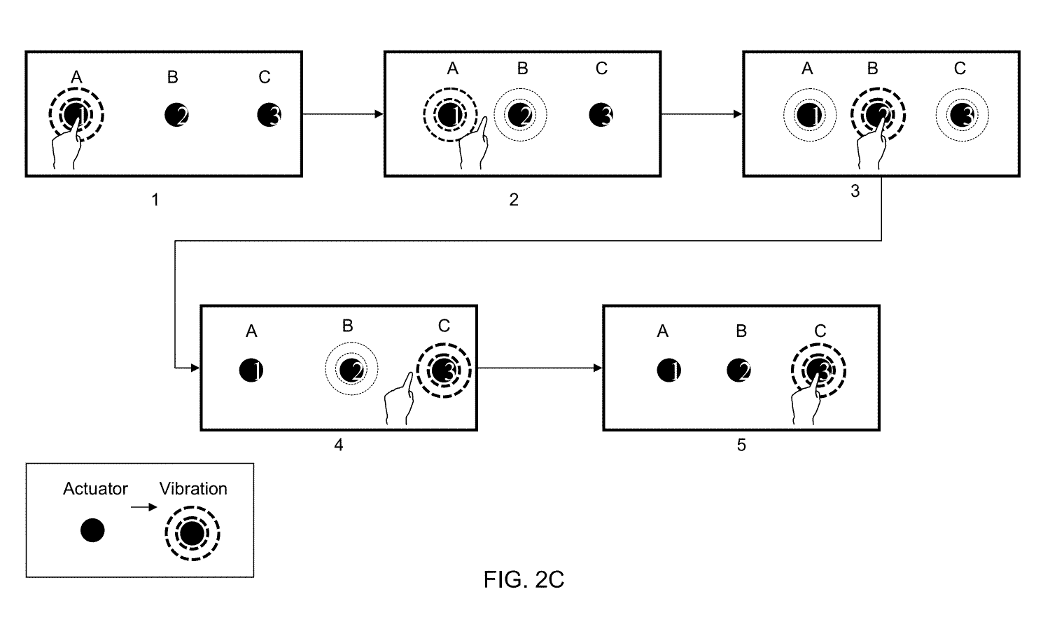

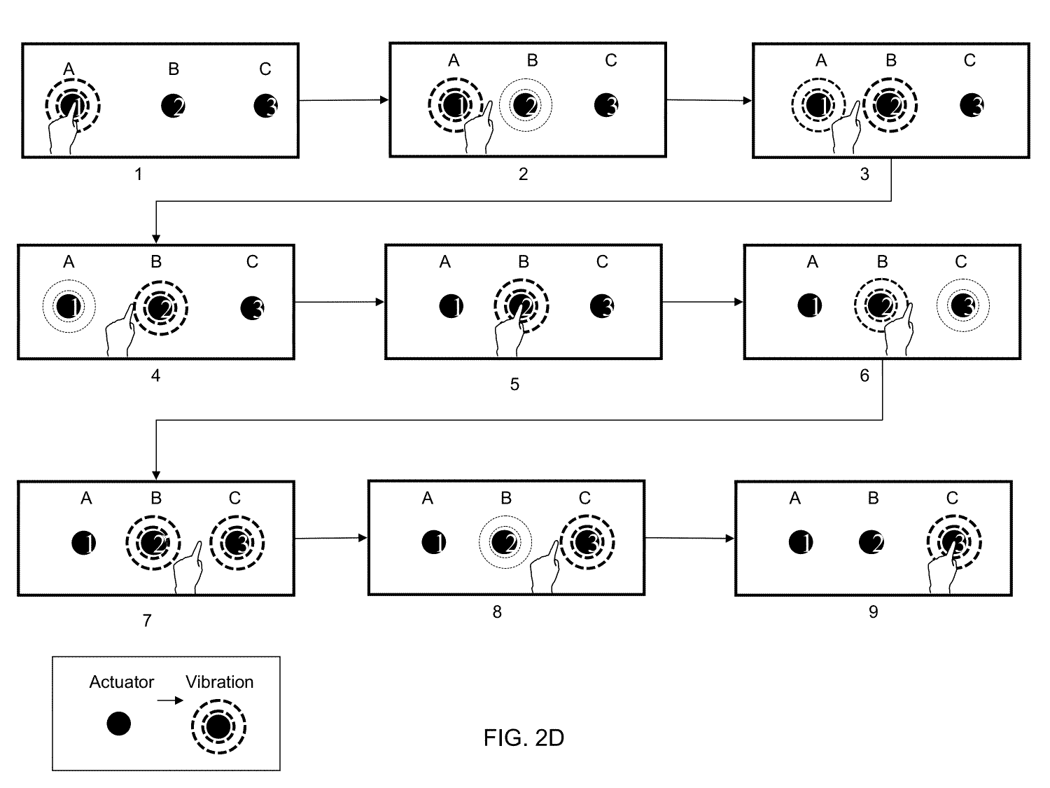

Referring to the examples of FIG. 2(A-D), an embodiment uses actuator location in combination with the amplitude, frequency and duration of haptic responses to convey a sense of direction to users. Simulating a ‘phi phenomenon’ between actuators can create a sense of direction. The ‘phi phenomenon’ is the tactile illusion of two separate stimuli perceived as one moving stimulus. To direct users, actuators of an embodiment work together, i.e., in combination. Each actuator may engage at a different time (or the same time or any time in a sequence) and with the same or different amplitude, frequency, and/or duration as the other actuators. Examples of actuator timing and intensity patterns are given in FIG. 2(A-D) as non-limiting examples. The amplitude, frequency, and/or duration of the haptic response can be modified (e.g., in terms of intensity) for different events. The phi phenomenon is then created by a ‘hand-off’ between actuators (i.e., actuators take turns to create the perception of motion between actuators).

Embodiments therefore employ predetermined haptic patterns using a combination of actuators. The predetermined pattern may be mapped to a sensed input. Thus, for example, following a sensed input, e.g., at a touch screen, an embodiment may use a haptic response from the closest actuator to the sensed input to gain the user's attention. An embodiment may then provide directional cues by activating other haptic response(s) from the farther actuator(s) according to the predetermined pattern. The predetermined pattern may be selected therefore based on the context, e.g., input sensed at a left side of a touch screen audio application, whereas audio controls are located at the right side of the touch screen. Thus, an initial actuator is activated proximate to the touch input, with a predetermined pattern of actuator activation guiding the user in the direction (e.g., of the audio or other controls, not illustrated) at the right side of the touch screen. This is illustrated in FIG. 2A as sequential activation of actuators A, B and C in the numbered steps (1-3).

Such actuators can use the same or different levels of amplitude, frequency, and/or duration in forming the predetermined pattern of haptic feedback, as illustrated in FIG. 2(B-D). In FIG. 2(A-D), the weight of the lines corresponds to intensity of vibration (e.g., greater weight in lines surrounding an actuator indicates greater frequency, duration and/or amplitude of the actuator vibration). The number of actuators in the directional haptic feedback sequence will depend on the desired fidelity of the directional haptic feedback.

FIG. 2B illustrates an example of providing haptic feedback using more than one actuator at a time in a pattern including steps 1-5. Therefore, at first actuator A is activated (e.g., an actuator proximate to user input). Thereafter, both actuator A and actuator B are activated. All three actuators (A-C) may be activated in a following step, providing a progressively richer tactile feedback to the user. Thereafter, reducing or elimination of actuator A reinforces the directional cue towards actuator C. This progresses by thereafter reducing or eliminating actuator B as well as actuator A, leaving the targeted area and actuator (actuator C) active. This progressive actuation/de-actuation may be varied in time and/or intensity and furthermore matched to a user's progression via input sensing (e.g., touch sensing), as illustrated in FIG. 2(C-D).

In the examples of FIGS. 2C and 2D, a homing feedback may be provided that guides a user's finger to the appropriate location(s). Therefore, in the example of FIG. 2C, a user is provided varying haptic feedback from actuators A-C in the fashion indicated by steps 1-5, depending on the location of the user's finger relative to the actuators A-C. Therefore, in the example of FIG. 2C, the actuators may guide the user to move his or her finger in a particular direction, e.g., to the right. Additionally or in the alternative, the actuators may provide feedback indicating the locations of various underlying controls (e.g., play/pause, skip forward and skip back) using the actuators with varying haptic feedback.

Thus, referring to FIG. 2C, a music player “play/pause” control is mapped to the location of actuator B, with a particular amplitude or frequency or duration, whereas actuators A and C are mapped to other controls, e.g., skip back and skip forward. Thus, haptic feedback may inform or re-enforce the user's understanding of what input he or she is providing or is able to provide at a given location. This way, the user may know which control his or her input is located near with only receiving haptic feedback. This reduces the need to for the user to obtain additional (e.g., visual) feedback in order to locate or operate the control. As can be appreciated from FIG. 2D, refined directional cues may be provided to the user such that the user senses a moving direction cue (e.g., from left to right in FIG. 2D), guiding his or her finger in that direction using the example steps 1-9 of a predetermined pattern.

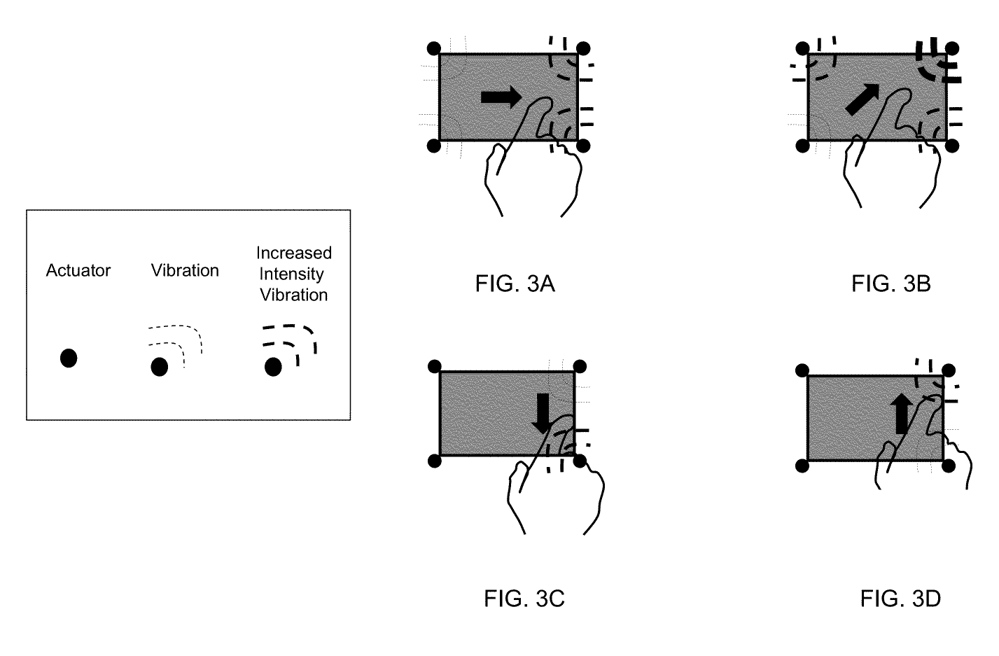

FIG. 3(A-D) illustrates examples of using peripherally located actuators (e.g., in the corner of a touch pad or touch screen). A user may be given feedback when movement towards a right edge (FIG. 3A) or to a particular corner (FIG. 3B) is reaching the usable limit of the surface, e.g., using appropriate actuators (alone or in combination). Moreover, a user may receive feedback regarding scrolling (up and down type movements) using actuators located on a particular side of the device, as illustrated in FIG. 3(C-D). Therefore, a user may receive haptic feedback regarding where the edges of the surface are, as for example encountering increasing haptic feedback as the edge or corner (limit actuator) in question is approached.

An embodiment may create a sense of direction by modifying the timing of actuation and modulating the following, non-limiting actuator characteristics. For instances with two actuators, the same amplitude, frequency, and/or duration at the initial actuator may also be employed at the farther actuator, i.e., actuator A is equal to actuator B (in terms of amplitude, frequency or duration of oscillation). Alternatively, different amplitude, frequency, and/or duration (with respect to the initial actuator) may be used at the farther actuator, i.e., actuator A does not equal actuator B.

For instances with three actuators, the same amplitude, frequency, and/or duration at the initial actuator may be used at the farther actuators, i.e., actuator A equals actuator B, which in turn equals actuator C. In the alternative, different amplitudes, frequencies, and/or duration may be used at the farther actuators, i.e., actuator A does not equal actuator B, which in turn does equal actuator C. In the alternative, different amplitudes, frequencies, and/or duration may be used at the farthest actuator when compared to the closer actuators, i.e., actuator A equals actuator B, which in turn does not equal actuator C. Alternatively, different amplitudes, frequencies, and/or duration may be used at each actuator, i.e., actuator A does not equal actuator B, which in turn does not equal actuator C.

For instances with four or more actuators, the same amplitude, frequency, and/or duration as at the initial actuator may be used at the farther actuators. Moreover, different amplitudes, frequencies, and/or duration may be used at the initial actuator and at the farther actuator(s). Different amplitudes, frequencies, and/or duration at each actuator may be used in a variety of ways. For example, varying distances (actuators grouped by distance from an initial actuator, with group sizes able to vary) may be employed, with different amplitudes, frequencies, and/or duration at the varying actuator groups. Moreover, different amplitudes, frequencies, and/or duration may be used at each actuator. Those having ordinary skill in the art will understand that more combinations may be used with more actuators available. Moreover, the amplitude, frequency, and/or duration may change as the input device is physically moved or repositioned/reoriented.

Circumstances in which directional haptic feedback is provided include guiding the user's input to a physical area on the device. This includes but is not limited to the following use scenarios. When a user's input is reaching the edges in programs, haptic feedback is provided to direct the user back to a usable area, e.g., one occupied by a control button of an underlying application. Similarly, when a user's input is reaching an edge in an operating area, haptic feedback may be used to direct the user back to a usable area of the operating area. When a user's input is reaching a limit (e.g., minimum/maximum zoom), haptic feedback provides feedback of available intensity (e.g., zoom) direction. In a page down/up scenario, e.g., scrolling to the bottom/top of a displayed page, haptic feedback may be provided indicating an available direction of movement or scrolling. When a user input is reaching an edge of a touch pad or touch screen, haptic feedback may direct the user back to a usable area via providing directional cues.

The directional haptic feedback may also be used for haptic feedback of motions. These include but are not limited to, using a scroll function (where haptic feedback provides feedback for scroll direction), zooming in/out (where haptic feedback provides feedback for increasing/decreasing the size), swipe and flick motions (where haptic feedback helps users discriminate between these gestures).

This directional haptic feedback may be used to enhance or supplement a variety of other types of feedback, such as audio and visual feedback. For example, when using a scrolling function, users may receive visual feedback of the slider moving up and down. However, if a user is not looking at that slider, then he or she does not know when the top or the bottom will be reached. With the directional haptic feedback, users do not need to continuously check the slider to know when they have reached the top or the bottom, or even when these are approaching. Thus, directional haptic feedback may also be used to let users know when they are approaching the top or bottom by changing the intensity of the actuators.

Users may adjust the directional feedback to fit their preferences for each type of interaction. Also, like most other forms of feedback, it is possible to disable this haptic feedback for specific events or globally.

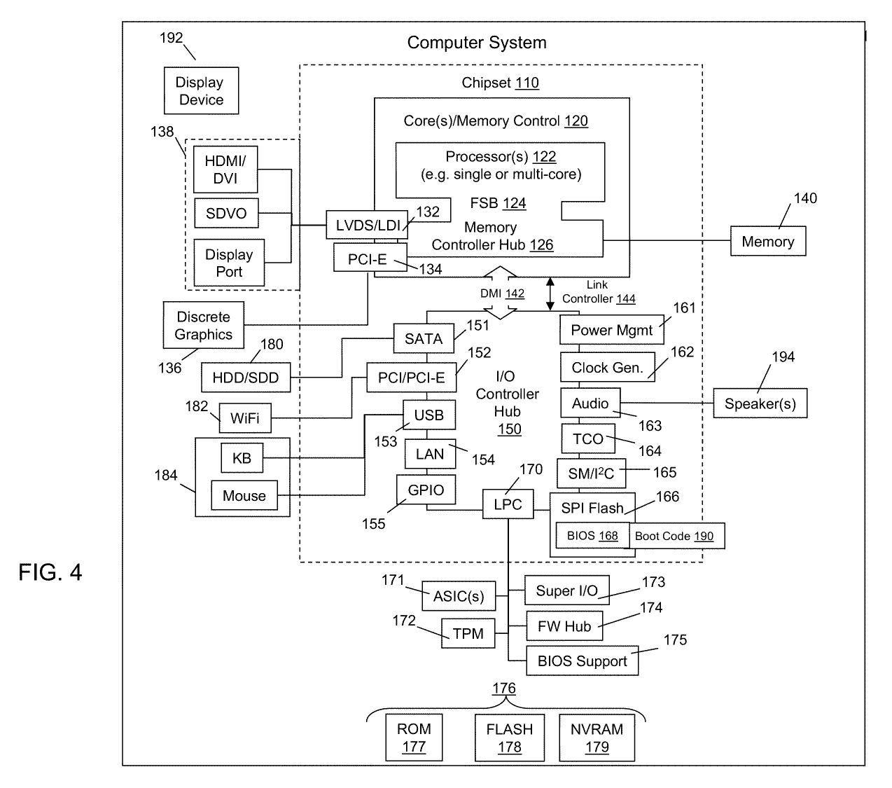

Referring to FIG. 4, while various other circuits, circuitry or components may be utilized, an example is illustrated in FIG. 1 that depicts a block diagram of one example of information handling device circuits, circuitry or components. The example depicted in FIG. 4 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 4.

The example of FIG. 4 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 4, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 4, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 4, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, which may be used in connection with managing battery cells, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 4.

Information handling devices, as for example outlined in FIG. 4, may include various touch sensitive surfaces, such as a capacitive touch screen. As described herein, the touch sensitive surface may have one or more actuators embedded therein or operatively coupled thereto for providing haptic feedback.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.”Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be any non-signal medium, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), a personal area network (PAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting touch input at a surface of a touch sensitive device; and
activating one or more actuators to provide haptic feedback in response to the touch input at the surface of the touch sensitive device;
the haptic feedback comprising a tactile indicator created via modulating one or more of: actuator frequency, actuator amplitude, and actuator duration.

2. The method of claim 1, wherein the tactile indicator comprises a directional cue provided via activation of:
an actuator proximate to the detected touch input; and
one or more other actuators.

3. The method of claim 2, wherein the actuator proximate to the touch input and the one or more other actuators are activated according to a predetermined pattern.

4. The method of claim 3, wherein the predetermined pattern is a directional pattern for guiding a user to provide touch input to another area of the surface of the touch sensitive device.

5. The method of claim 4, wherein the predetermined patter creates a phi phenomenon whereby two actuators appear tactilely as one actuator.

6. The method of claim 5, wherein the directional cue comprises a moving tactile indicator guiding further input of the user.

7. The method of claim 2, wherein actuator proximate to the input and the one or more other actuators provide haptic feedback differing in one or more of: frequency of oscillation, duration of oscillation, and amplitude of oscillation.

8. The method claim 7, wherein the one or more actuators are grouped; and
wherein a group of actuators provides grouped haptic feedback with respect to one or more of frequency, amplitude and duration of haptic feedback.

9. The method of claim 1, wherein the tactile indicator comprises an intensity cue.

10. The method of claim 9, wherein the intensity cue comprises a haptic cue that varies according to the input intensity of input provided to an underlying, running application.

11. The method of claim 10, wherein the intensity of input provided to the underlying, running application varies according to one of location intensity and level intensity.

12. The method of claim 11, wherein location intensity increases near the edge of a zone of the surface of the touch device tied to an underlying application input boundary.

13. The method of claim 12, wherein the underlying application input boundary comprises one of: an application button and an application page boundary.

14. The method of claim 10, wherein a level intensity comprises a volume level and a zoom level.

15. An information handling device, comprising:
one or more processors;
a touch sensitive device having a touch sensitive surface;
one or more actuators; and
a memory operatively coupled to the one or more processors that stores instructions executable by the one or more processors to perform acts comprising:
detecting touch input at the surface of the touch sensitive device; and
activating the one or more actuators to provide haptic feedback in response to the touch input at the surface of the touch sensitive device;
the haptic feedback comprising a tactile indicator created via modulating one or more of: actuator frequency, actuator amplitude, and actuator duration.

16. The information handling device of claim 15, wherein the tactile indicator comprises a directional cue provided via activation of:
an actuator proximate to the detected touch input; and
one or more other actuators.

17. The information handling device of claim 16, wherein the actuator proximate to the touch input and the one or more other actuators are activated according to a predetermined pattern.

18. The information handling device of claim 17, wherein the predetermined pattern is a directional pattern for guiding a user to provide touch input to another area of the surface of the touch sensitive device.

19. The information handling device of claim 15, wherein the tactile indicator comprises an intensity cue.

20. A program product, comprising:
a storage medium having computer program code embodied therewith, the computer program code comprising:
computer program code configured to detect touch input at a surface of a touch sensitive device; and
computer program code configured to activate one or more actuators to provide haptic feedback in response to the touch input at the surface of the touch sensitive device;
the haptic feedback comprising a tactile indicator created via modulating one or more of: actuator frequency, actuator amplitude, and actuator duration.
